(19) United States
(12) Patent Application Publication
(10) Pub. No.: US 2026/0206879 A1
(43) Pub. Date: Jul. 23, 2026

(54) A Heating Unit for an Aerosol Generating Device

(71) Applicant: JT International SA, Geneva (CH)

(72) Inventors: Alec Wright, Guildford (GB); Jaakko McEvoy, Vienna (AT)

(73) Assignee: JT International SA, Geneva (CH)

(21) Appl. No.: 19/157,752

(22) PCT Filed: Feb. 16, 2024
(86) PCT No.: PCT/EP2024/053945

§ 371 Date: Aug. 19, 2025

(30) Foreign Application Priority Data
Feb. 24, 2023 (EP) 23158431.9

(51) Int. Cl. A24F 40/70; A24F 40/46; H05B 3/06; H05B 3/14

(52) U.S. Cl. CPC A24F 40/70; A24F 40/46; H05B 3/06; H05B 3/141; H05B 2203/017

(57) ABSTRACT

A heating unit for an aerosol generating device includes a heater defining a heating chamber that can receive an aerosol generating substrate. The heating unit also includes a frame configured at least partially to enclose the heater, wherein the frame is thermally moulded to the heater, such that the frame is sealed to the heater.

### FIELD OF THE INVENTION

The present invention relates to a heating unit for an aerosol generating device.

### BACKGROUND

There is a demand for aerosol generating devices that heat, but do not burn, a solid or semi-solid aerosol forming substrate which comprises tobacco. The aerosol generating substrate is typically heated in a heating chamber by a heater and the produced aerosol is inhaled by a user from a mouthpiece.

An issue present with these devices is that the produced aerosol may leak from the heating chamber into regions of the device other than the mouthpiece. It is important to prevent this type of leakage as it may cause damage to other components of the device, amongst other issues.

Furthermore, commercially available sealants that are appropriate for food-grade use are typically ineffective at preventing this aerosol leakage. This is due to the fact that these particular sealants are susceptible to damage by repeated heating and cooling over extended use of the aerosol generating device. Sealants that are effective at preventing this aerosol leakage are typically not appropriate for food-grade use.

It is an object of the present invention to provide a heating unit for an aerosol generating device that can prevent or mitigate the issues associated with undesirable aerosol leakage.

### SUMMARY OF INVENTION

Described herein is a heating unit for an aerosol generating device, comprising: a heater defining a heating chamber that can receive an aerosol generating substrate; and a frame configured at least partially to enclose the heater, wherein the frame is thermally moulded to the heater, such that the frame is sealed to the heater.

In an aspect of the present invention there is provided a heating unit for an aerosol generating device, comprising: a heater defining a heating chamber that can receive an aerosol generating substrate, wherein the heater is configured to be in direct contact with the aerosol generating substrate when the aerosol generating substrate is received in the heating chamber; and a frame configured to only partially enclose the heater, wherein the frame is thermally moulded to the heater, such that the frame is sealed to the heater.

In this way, the frame can be tightly bonded to the heater thereby forming a unitary component, and thus preventing unwanted aerosol leakage from regions of the heating chamber not enclosed by the frame. The frame will generally comprise an opening that is fluidly connected to a mouthpiece of the device from which the user can inhale the generated aerosol. To form the heating unit the heater may be placed in a mould with the frame material injected into the mould. Alternatively, the frame may be affixed to the heater and subsequently heated to mould the frame to the heater to form the bonded heating unit. In a further alternative, the frame may be crimped to the heater after it has been heated in order to achieve a seal.

Preferably, the heater comprises one or more bonding features configured to engage with the frame. In this way, the strength of the seal between the heater and the frame can be improved as the heater and the frame are more tightly bonded together.

Preferably, at least one of the one or more bonding features comprises one or more holes that are provided through the heater. Preferably, the frame comprises a securing portion that extends through the one or more holes, thereby securing the frame to the heater. In this way, the frame penetrates into and through the heater thus further securing the seal between the frame and the heater.

Preferably, the securing portion comprises a lug. In this way, the frame is riveted to the heater thereby improving the bond between the frame and the heater. The strength and durability of the heating unit may also be improved.

Preferably, the frame comprises a thermoplastic material. The frame may comprise PEEK, for example. In this way, the frame can be thermally moulded to the heater and subsequently cooled to form a tight seal. The frame should preferably comprise a material that has a melting point temperature above that of the operating temperatures of the heater of the heating unit.

Described herein is a method of forming a heating unit for an aerosol generating device, comprising: heating a frame material; moulding the frame material to a heater to at least partially enclose the heater; and cooling the frame material to form a seal with the heater.

In another aspect of the present invention there is provided a method of forming a heating unit for an aerosol generating device, comprising: heating a frame material; moulding the frame material to a heater, the heater defining a heating chamber that can receive an aerosol generating substrate, to only partially enclose the heater, wherein the heater is configured to be in direct contact with the aerosol generating substrate when the aerosol generating substrate is received in the heating chamber; and cooling the frame material to form a seal with the heater.

Preferably, the method further comprises moulding the frame material to at least one of one or more bonding features in the heater. The frame material may be moulded to at least one of one or more bonding features in the heater by injecting the heated frame material into a mould in which the heater is provided. The heated frame material then surrounds the heater and penetrates into the one or more bonding features as more heated frame material is injected into the mould.

Preferably, the method further comprises, before the heating step, extending a securing portion of the frame material through one or more holes in the heater. In this way, the frame material may penetrate into and through the heater thus further tightening the seal between the frame material and the heater once the heating unit has been formed. The frame material may already have been produced and moulded to a shape to fit to the heater. In this example, the frame material and the heater are then interlocked to extend a securing portion of the frame material through one or more holes in the heater. Alternatively, this step may be achieved by injecting heated frame material through one or more holes in the heater.

Preferably, moulding the frame material to the heater comprises moulding the securing portions of the frame material to the heater. In this way, the frame material is riveted to the heater thereby improving the bond between the frame material and the heater. The strength and durability of the formed heating unit may also be improved. Once the securing portion of the frame material has been extended through one or more holes in the heater the securing portions of the frame material can be moulded to the heater. The moulding of the securing portion to the frame can be achieved by heating and applying pressure to the securing portion.

In another arrangement the frame material may be in the form of pellets before the heating step. This is an example of overmoulding where the frame material can be positioned around the heater and then heated until it is in a fluid-like state so that it is thermally moulded to the shape of the heater. The frame material can then be cooled to solidify around the heater and form a seal that prevents or at least mitigates undesirable leakage of vapour.

### BRIEF DESCRIPTION OF DRAWINGS

Embodiments of the invention are now described, by way of example, by reference to the drawings, in which:

FIG. 1 is a perspective view of an aerosol generating device comprising a heating unit in an embodiment of the invention;

FIG. 2 is a perspective view of a heating unit for an aerosol generating device in an embodiment of the invention;

FIG. 3 is a schematic cross-sectional diagram of a heating unit for an aerosol generating device in an embodiment of the invention;

FIG. 4 is a schematic cross-sectional diagram of a heating unit for an aerosol generating device in another embodiment of the invention;

FIG. 5 is a schematic cross-sectional diagram of a heating unit for an aerosol generating device in another embodiment of the invention;

FIG. 6 is a schematic cross-sectional diagram of a heating unit for an aerosol generating device in another embodiment of the invention;

FIG. 7 is a flow diagram of a method for forming a heating unit for an aerosol generating device in an embodiment of the invention; and

FIG. 8 is a schematic cross-sectional diagram of a method for forming lugs in a heating unit for an aerosol generating device in the embodiment of the invention.

### DETAILED DESCRIPTION

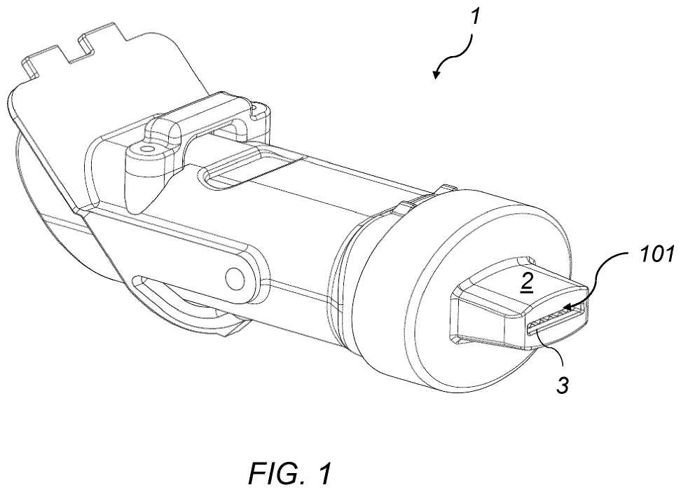

FIG. 1 is a perspective view of an aerosol generating device 1 comprising a heating unit in an embodiment of the invention. The heating unit is provided internally within the aerosol generating device 1. An aerosol generating substrate 101 is provided within the aerosol generating device 1 and within the heating unit. The aerosol generating device 1 comprises a mouthpiece 2 from which a user can inhale an aerosol produced when the aerosol generating substrate 101 is heated by the heating unit.

The heating unit is connected to a power source, such as a battery, that is provided within the aerosol generating device 1.

The aerosol generating substrate 101 extends from within the heating unit to within the mouthpiece 2. The mouthpiece 2 comprises an aperture 3 that is fluidly connected to the heating unit. The mouthpiece 2 is shaped such that a user can place their lips around the outer surface and inhale aerosol through the aperture 3.

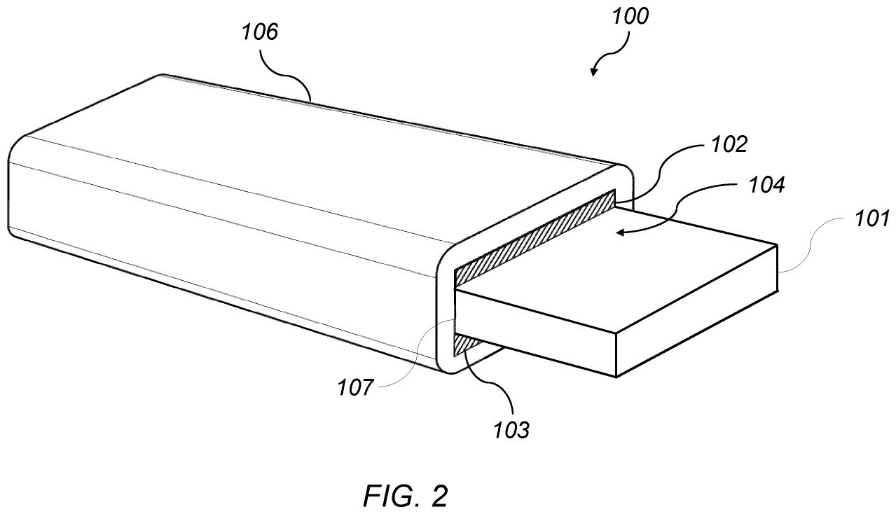

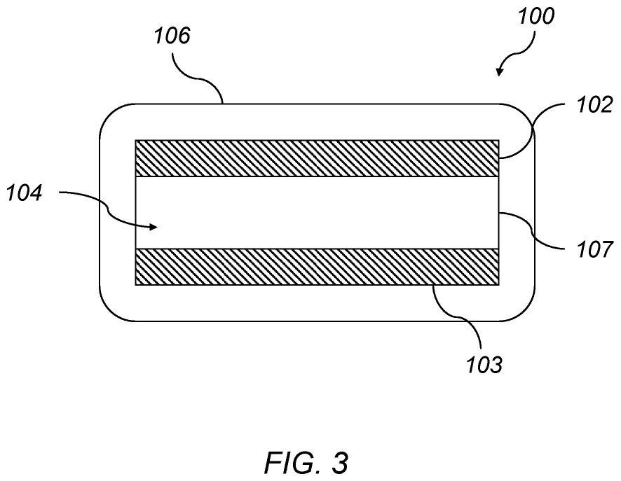

FIG. 2 is a schematic diagram of a heating unit 100 for an aerosol generating device in an embodiment of the invention. In the example of FIG. 2 an aerosol generating substrate 101 is provided partially within the heating unit 100, and partially extending out of the heating unit 100. The aerosol generating substrate 101 is removable from the heating unit 100 so that it can be replaced once it is depleted. FIG. 3 is a schematic cross-sectional diagram of a heating unit 100 in an embodiment of the invention. In the embodiment of FIG. 3 an aerosol generating substrate is not provided within the heating unit 100.

The heating unit 100 has a generally elongate rectangular shape. The heating unit 100 comprises a first heating element 102 and a second heating element 103 that may be referred to collectively as a heater. The first and second heating elements 102, 103 are separated from each other and define a heating chamber 104 therebetween, within which an aerosol generating substrate 101 can be inserted. The heating unit 100 also comprises a frame 106 that supports and partially encloses the first and second heating elements 102, 103, and therefore also partially encloses the heating chamber 104. The frame is thermally moulded to the first and second heating elements 102, 103. The frame 106 comprises an opening 107 that defines an opening of the heating chamber 104. The frame 106 encloses the first and second heating elements 102, 103 around all surfaces, except at the opening 107.

The heating unit 100 is electrically and mechanically connected to the body of an aerosol generating device. The first and second heating elements 102, 103 may therefore be electrically connected a power source, such as a battery, in the body of the aerosol generating device. The frame 106 can be moulded around such electrical connections so that power can be provided to the first and second heating elements 102, 103.

The first and second heating elements 102, 103 are spaced apart so that that an aerosol generating substrate can be snugly received in the heating chamber 104. The first and second heating elements 102, 103 are configured to produce to heat during operation of the aerosol generating device. This is to heat the aerosol generating substrate 101, when received in the heating chamber 104. The first and second heating elements 102, 103 are typically in direct contact with opposing major surfaces of the aerosol generating substrate, when such a substrate 101 is received in the heating chamber 104.

In this embodiment the first and the second heating elements 102, 103 are substantially planar ceramic heating elements. Other types of heaters, such as a trace heater, may also be used.

The frame 106 is sealed to the first and second heating elements 102, 103 to prevent aerosol leakage from the heating chamber 104 except from at the opening 107. This is achieved by providing frame material 106 around five of the six surfaces that form the substantially rectangular prism that forms the heating unit 100. Frame material is absent only at the front surface, where the opening 107 is located.

In this example, the frame 106 comprises a thermoplastic material (PEEK, for example). The thermoplastic material is heated such that it becomes malleable to allow the frame 106 to be moulded to the first and second heating elements 102, 103. This forms a tight seal between the frame 106 and the first and second heating elements 102, 103 upon cooling of the thermoplastic material.

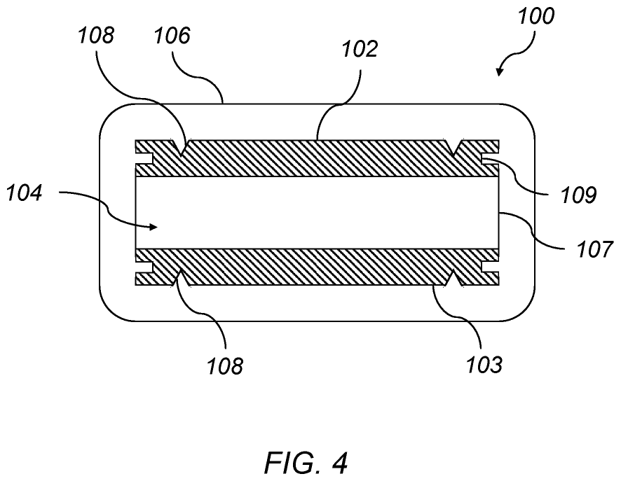

FIG. 4 is a schematic cross-sectional diagram of a heating unit 100 for an aerosol generating device in another embodiment of the invention. In this configuration the first and second heating elements 102, 103 each comprise channels 108 in their respective major planar surfaces that make contact with the frame 106. Additionally, channels 109 are provided in the side surfaces of the first and second heaters 102, 103. The channels 108 and 109 collectively form bonding features.

The channels 108 in the first and second heating elements 102, 103 have a triangular cross-section and the channels 109 have a rectangular cross-section (although the skilled person will appreciate that these are simply examples). The channels 108, 109 are provided along the respective lengths of the first and second heating elements 102, 103. As the frame 106 is thermally moulded to the first and second heating elements 102, 103, the softened or malleable frame will tend to flow into the channels 108, 109 thereby to mould the frame 106 to the first and second heating elements 102, 103 and improve the strength of the bond.

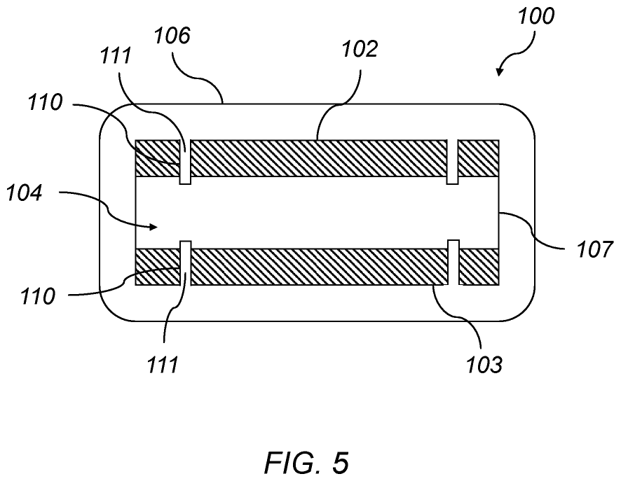

FIG. 5 is a schematic cross-sectional diagram of a heating unit for an aerosol generating device in another embodiment of the invention. In this configuration, holes 110 are provided through the first and second heating elements 102, 103. The holes 110 collectively form bonding features in the first and second heating elements 102, 103. The frame 106 comprises protrusions 111 that extend through the holes 110. The protrusions 111 are securing portions in this example. The holes 110 and the protrusions 111 interlock with each other to seal the frame 106 to the first and second heating elements 102, 103. The protrusions 111 of the frame 106 are also thermally moulded to the holes 110 of the first and second heating elements 102, 103.

In the embodiment of the invention according to FIG. 5, the protrusions 111 from the frame 106 are at least partially provided within the heating chamber 104. In other words, the protrusions 111 are slightly longer in length than the corresponding holes 110. In various embodiments, the protrusions 111 may instead be provided entirely within the holes 110.

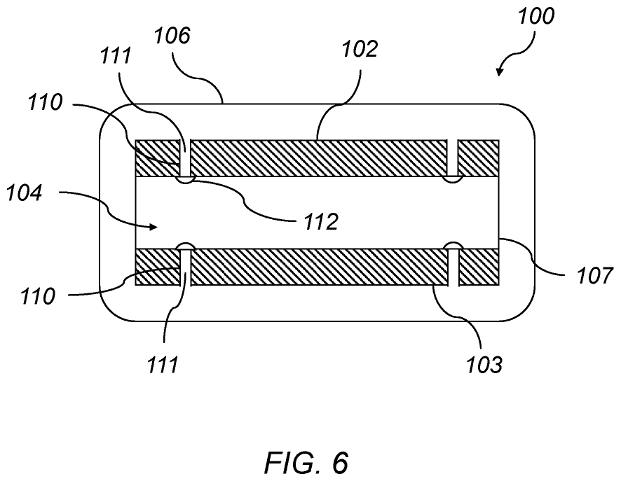

FIG. 6 is a schematic cross-sectional diagram of a heating unit 100 for an aerosol generating device in another embodiment of the invention. In this configuration, the protrusions 111 of the frame 106 comprise lugs 112.

In this embodiment of the invention, the protrusions 111 of the frame 106 extend at least partially into the heating chamber 104. More specifically, an end of each protrusion 111 of the frame 106 extends into the heating chamber 104 from the holes 110. The ends of the protrusions 111 that extend into the heating chamber 104 form the lugs 112. The lugs 112 have a radial cross-section greater than that of the corresponding holes 110.

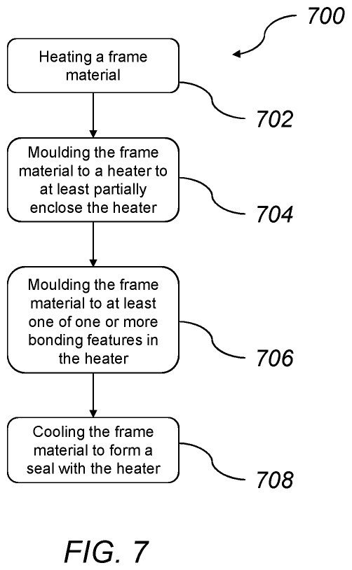

FIG. 7 is a flow diagram of a method 700 for forming a heating unit 100 for an aerosol generating device in an embodiment of the invention. The method comprises the steps of heating 702 a frame material, moulding 704 the frame material to a heater to at least partially enclose the heater, moulding 706 the frame material to at least one of the one or more bonding features in the heater and cooling 708 the frame material to form a seal with the heater.

At step 702, the frame material is heated. The frame material is heated such that it becomes molten or malleable. The frame material may be heated by heating in an oven or furnace or the like. The frame material should be heated to a temperature such that the heated frame material is suitable for injection moulding to enclose the heater in a subsequent moulding step. In embodiments of the invention in which the frame material comprises PEEK, the frame material should be heated to a temperature above the glass transition temperature of PEEK, which is approximately 143 degrees Celsius.

At step 704, the frame material is moulded to the heater to at least partially enclose the heater. This is achieved by placing the heater into a mould and injecting the heated or molten frame material into the mould. This step may be carried out by an overmoulding process, for example. Where the method involves overmoulding the frame material may be initially provided as a plurality of pellets that can be melted so that the frame material flows around the heater.

At step 706, the frame material is moulded to at least one of the one or more bonding features in the heater. This is also achieved by injecting the heated molten frame material into the mould in which the heater is placed. This step may also be carried out by an overmoulding process. The bonding features in the heater can be formed prior to the presently described moulding step in a further forming step.

At step 708, the frame material is cooled to form a seal with the heater. Once cooled, the frame material solidifies to form the heating unit. Once the frame material and the heater have been removed from the mould the frame material may be actively cooled by quenching or passively cooled by allowing the frame material to reach an ambient temperature.

In embodiments of the invention where the bonding features of heater comprises holes, the above method may further include the step of extending securing portions of the frame through one or more holes in the heater. This may be performed when the method starts with a solid frame material that already comprises projections, and then is subsequently heated so that it can be moulded to the shape of the heater. In this example, the solid frame material and the heater are brought together, and the protrusions 111 of the solid frame material are inserted through the holes 110 in the heater instead of the heated frame material being injected into the holes. This step could be performed prior to the step of heating the frame material.

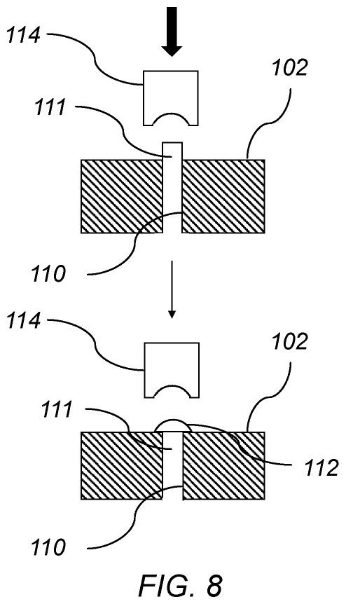

FIG. 8 is a schematic cross-sectional diagram of a method for forming lugs in a heating unit for an aerosol generating device in the embodiment of the invention. In this example a die 114 is provided to create lugs 112 by applying pressure to the ends of the protrusions 111 that protrude from the holes 110 in either of the heating elements 102, 103.

1. A heating unit for an aerosol generating device, comprising:
a heater defining a heating chamber configured to receive an aerosol generating substrate, wherein the heater is configured to be in direct contact with the aerosol generating substrate when the aerosol generating substrate is received in the heating chamber; and
a frame configured to only partially enclose the heater, wherein the frame is thermally moulded to the heater, such that the frame is sealed to the heater.

2. The heating unit according to claim 1, wherein the heater comprises one or more bonding features configured to engage with the frame.

3. The heating unit according to claim 2, wherein at least one of the one or more bonding features comprise one or more holes that are provided through the heater.

4. The heating unit according to claim 3, wherein the frame comprises a securing portion that extends through the one or more holes, thereby securing the frame to the heater.

5. The heating unit according to claim 4, wherein the securing portion comprises a lug.

6. The heating unit according to claim 1, wherein the frame comprises thermoplastic material.

7. The heating unit according to claim 1, wherein the heater comprises ceramic.

8. A method of forming a heating unit for an aerosol generating device, comprising:
heating a frame material;
moulding the frame material to a heater, the heater defining a heating chamber configured to receive an aerosol generating substrate, to only partially enclose the heater, wherein the heater is configured to be in direct contact with the aerosol generating substrate when the aerosol generating substrate is received in the heating chamber; and
cooling the frame material to form a seal with the heater.

9. The method of forming a heating unit according to claim 8, wherein the method further comprises moulding the frame material to at least one of one or more bonding features in the heater.

10. The method of forming a heating unit according to claim 9, wherein the method further comprises, before the heating step, extending a securing portion of the frame material through one or more holes in the heater.

11. The method of forming a heating unit according to claim 10, wherein moulding the frame material comprises moulding the securing portion of the frame material to the heater.

12. The method of forming a heating unit according to claim 8, wherein the frame material is in the form of pellets before the heating step.
